(19) United States
(12) Patent Application Publication
(10) Pub. No.: US 2009/0012996 A1
(43) Pub. Date: Jan. 8, 2009

(54) SYNDICATION OPTIMIZATION SYSTEM

(75) Inventors: Naveen Gupta, Sunnyvale, CA (US); Chyr-Chong Ting, San Jose, CA (US)

Correspondence Address: Yahoo! Inc., c/o Kenyon & Kenyon LLP, 333 W. San Carlos Street, Suite 600, San Jose, CA, 95110, US

(73) Assignee: YAHOO! INC., Sunnyvale, CA (US)

(21) Appl. No.: 11/772,766

(22) Filed: Jul. 2, 2007

(51) Int. Cl. G06F 17/00

(52) U.S. Cl. 707/104.1; 707/E17.005

(57) ABSTRACT

Aspects of the present invention include automating the process of determining the optimal channels for syndicating content. The automation process can be based on a plurality of factors weighted in accordance with a user's preferences. A further aspect of the present invention calls for dynamically updating the process of channel selection by continually updating the data used in the decision making process. Aspects of the present invention allow a user to apply their chosen factors at various levels of granularity such as for individual products, product lines, category of products, or company-by-company.

### FIELD OF THE INVENTION

The present invention relates generally to the field of internet commerce, and more particularly to the field of web syndication.

### BACKGROUND

The internet has increased access to information and options for purchasing goods and services. Consumers frequently can choose from hundreds of different products and businesses, and can access reviews of those products and businesses readily.

As a result, it can be challenging for sellers of goods and services to reach potential consumers. Online sellers devote significant time and resources to increasing the traffic on their websites because increased traffic translates into more potential consumers viewing their products and more sales. When possible, sellers also like to be able to target their products at the groups of people most likely to purchase them.

One effective means for an online seller to reach more potential consumers is by syndicating the seller's listings. Syndication involves a first company, sometimes referred to as a content provider, providing a second company, sometimes referred to as a distributor or syndicate, with content to incorporate into their website. The first company's content can be incorporated into the second company's website in the form of frames or a link, or the content can be fully integrated into the second company's site.

The decisions of what to syndicate and where to syndicate it are usually based on business considerations. For example, a smaller company may choose to only syndicate with free or inexpensive distributors. For a larger company, the decision might be more complicated and involve considerations such as the effects syndication of one product line might have on another product line, or the effects one company syndicating might have on affiliated companies.

Presently the decisions on what products to syndicate and which distributors to use are made manually. For companies with large volumes of listings to syndicate, this manual decision making means either lengthy delays or being able to do only a superficial analysis. Therefore, it would be desirable to improve the efficiency of the syndication process by automating aspects of that process.

### SUMMARY OF THE INVENTION

Aspects of the present invention include automating the process of determining channels for syndicating content. The automation process can be based on a plurality of factors weighted in accordance with a user's preferences. A further aspect of the present invention calls for dynamically updating the process of channel selection by continually updating the data used in the decision making process. Aspects of the present invention allow a user to apply chosen factors at various levels of granularity such as for individual products, product lines, category of products, or company-by-company.

### BRIEF DESCRIPTION OF THE DRAWINGS

FIG. 1 shows an illustration of a system embodying aspects of the present invention.

FIG. 2 is a flow chart illustrating a method embodying aspects of the present invention.

### DETAILED DESCRIPTION

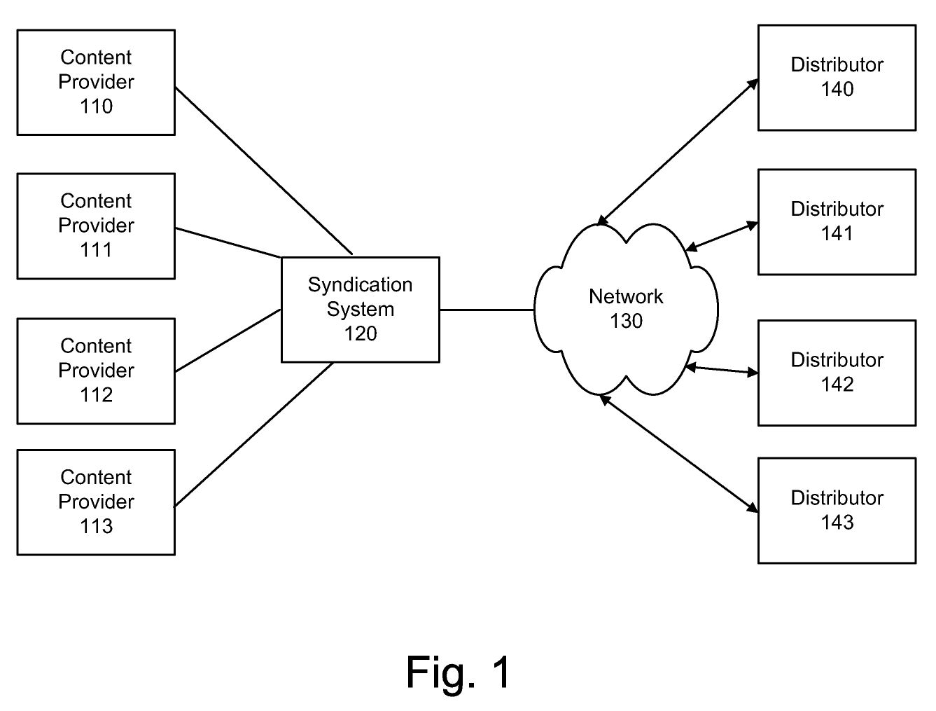

FIG. 1 illustrates a system embodying aspects of the present invention. Content such as a listing for a product or service can be generated by a content provider 110-113. The content provider can send the content to a syndication system 120 which can be implemented on a centralized server. The syndication system 120 can use a number of factors to determine the distributors 140-143 with which to syndicate the content. The syndication system 120 can relay the content to the preferred distributors 140-143 over a network 130 such as the internet. A more detailed description of the types of factors that might be used will be discussed in more detail later in this description.

Examples of content providers 110-113 might include companies like Yahoo! Hot Jobs or Yahoo! Autos. Examples of distributors 140-143 might include local newspaper websites, industry websites, or any other websites that carry either employment listings or automobile listings. Content providers 110-113 and distributors 140-143 may enter into any number of different business agreements. For example, a distributor 140-143 may assess fees based on a per day charge, a flat fee, the click through rate, a percentage of the selling price, or in some other manner, or not charge at all. The content provider 110-113 may provide to the distributor 140-143 a link that redirects customers from the distributor's 140-143 webpage to the content provider's 110-113 webpage. Alternatively, the content provider's 110-113 listing may be incorporated into the distributor's 140-143 webpage in a manner that does not indicate the listing's origin. In this latter circumstance, a purchase can be completed through the distributor 140-143 rather than through the content provider 110-113.

An ordinarily skilled artisan will appreciate that the configuration shown in FIG. 1 is merely illustrative of one embodiment. Many other configurations can be contemplated without varying from the spirit of the present invention. For example, rather than having a centralized syndication system 120 each content provider 110-113 may have its own syndication system 120. Alternatively, a content provider 110-113 may be a series of local area networks each having multiple content providers. Additionally, instead of having the syndication system 120 route content directly to distributors 140-143, the syndication system 120 can send recommendations back to a content provider 110-113 so that the recommendations can be manually reviewed before being sent to distributors 140-143.

Additionally, an ordinary skilled artisan will appreciate that although the syndication system 120 is described as operating primarily at an individual listing level, it can also operate at a feed level where multiple listings may be grouped together for purposes of determining syndicates. For example, a content provider syndicating listings for home appliances may determine distributors for every unique model of appliance individually, or they may determine syndicates based on the type of appliance (e.g. refrigerator, microwave, etc.), the brand of appliance (e.g. GE®, Bosch®), the cost of the appliance (e.g. greater than $1000, less than $1000), or any other type of grouping.

4 Any number of different quantitative factors can be used in the syndication decision making process. A content provider might want to weight the factors for syndicating their products in a way that increases profitability and return on investment while also giving consideration to long term impact on brand and company reputation. This can be done through the implementation of rules that balance multiple factors, establish thresholds for individual factors, or a combination of both.

As alluded to above, one parameter a content provider may want to consider is the price per listing. If a particular distributor charges per click or per day rather than a flat fee, then the syndication system might formulate estimates regarding how much a particular listing will cost. The content provider may have a rule stating that it will not syndicate with distributors who charge more than $5 per listing. Alternatively the rule might be that the content provider will not syndicate with distributors who charge more than two percent of the price of the product per listing. If the price of the listing is greater than the maximum price set by the rule, then the syndication system will not syndicate with that particular distributor regardless of how other factors might weigh.

If the price of the listing is less than the maximum price set by the rule, then the syndication system might have an additional rule that weighs other factors with the price factor before deciding which distributors to syndicate with. Upon considering the other factors, the syndication system may determine that a threshold level is met and a product should be syndicated with a particular distributor, or that the threshold level is not met and the product should not be syndicated with a particular distributor. The various rules, the weights given each factor, and the threshold level can all be determined by a user based on business considerations.

In addition to knowing the cost of a listing, a content provider might also want to know what returns a listing produces. For example, with unique listings, such as automobiles or jobs, the content provider might want to know what percentage of listings with a particular distributor result in sales and the length of time before the sales occur. For listings of non-unique products that have renewable supplies, such as DVDs or household appliances, the content provider might want to know about the frequency of sales.

If the distributor lists a link to the content provider's website, then the content provider might want to track the amount of traffic generated for the content provider's website, in addition to the number of sales that result from that traffic. Additional traffic, even if it does not directly result in a sale of the listed product, might still have a value if it increases a consumer's familiarity with the content provider's website, leads to sales of other products on their site, or results in increased ad revenue. The present invention can allow a content provider to easily assess the value of additional traffic versus the traffic acquisition cost.

In addition to considering the quantity of traffic a distributor generates, the content provider might also want to consider the quality of the traffic by assessing the expression of interest (EOI) generated per listing. By tracking a potential customer's IP address, using cookies, or using any other tracking means known in the art, a content provider can determine the likelihood of a potential customer's purchasing a product in the future if the customer does not purchase immediately. For example, if a user follows a link from a newspaper site to a listing on Yahoo! Autos, the user's actions while on the Yahoo! Autos site might indicate whether the user is a likely purchaser or merely someone who is curious but not likely to buy. For example, it may be determined that reviewing financing and warranty information is a stronger EOI than only looking at pictures. By tracking the number of people who view financing and warranty information, a content provider can assess EOI per listing and, consequently, more accurately value the traffic a distributor directs to the provider's website.

EOI may also be determined by tracking the time a user spends on a particular website or the number of clicks while on the site. Additionally, EOI might be determined by tracking only a subset of users rather than every user.

Depending on the business model, using the same methods referenced above, a content provider may also wish to track the number of one-time customers delivered by a particular distributor versus the number of repeat customers. A seller of DVDs, for example, might place a higher premium on repeat customers than a seller of higher-priced, less frequently-purchased items such as boats. In such a case, the seller of DVDs can weight the repeat customer factor more highly in the syndication decision making process than the seller of boats.

Another factor that a content provider may use in syndication processing is long term brand impact and company image impact. If a content provider manufactures household appliances, and syndicates listings for appliances with a particular distributor, the reputation of the distributor might be imputed to the brand of appliance. Also, distributors may act as online storefronts or transaction facilitators, but the transaction itself will be between the content provider and a customer. In an arrangement of this nature, faults or problems with the distributor providing the online storefront might negatively impact the reputation of the content provider. In order to protect the reputation of brands and business, a content provider might wish to monitor a distributor's reputation when determining who to syndicate with. Determination of a distributor's reputation may be done by monitoring user feedback or through one of many other methods. As with any other factor considered by the syndication system, a content provider may implement a rule where it does not syndicate with distributors whose reputation is below a certain threshold. Alternatively, the content provider may implement a rule to balance the reputation factor against other factors.

Another factor a content provider might want to use in syndication processing is category expertise. A particular distributor may be stronger for certain types of products than for others. An aspect of the present invention allows content providers to analyze the performance of distributors based on the types of products being sold. For example, a particular distributor may produce better results for kitchen appliances than they do for consumer electronics. Category expertise can be used in conjunction with or independent of other factors. For example, if a content provider is selling a model of microwave that it has sold before, then the content provider may choose to base the syndication decision solely on data related to that particular model of microwave. If, however, a content provider is syndicating a type of microwave that it has not syndicated before or only has limited data on, then the content provider may base its syndication decision in part on distributors' category expertise as it relates to selling microwaves or household appliances.

Another factor that can be considered in the syndication decision making process is cannibalization, which can result in less traffic for the website of the content provider or websites affiliated with the content provider. For example, suppose Yahoo! Hot Jobs or Yahoo! Autos uses a distributor to host a listing and links to that listing from the Yahoo! Hot Jobs or Yahoo! Autos site. Under this sort of arrangement, the distributor site might provide a superior means of presenting a listing or facilitating a transaction, but by using the distributor, the content provider runs the risk of familiarizing a consumer with a competing website. Through the various tracking methods referenced above, a content provider can monitor cannibalization by keeping track of whether or not the usage of the content provider's site decreases for a particular user after being introduced to the distributor's page. A user of a syndication system embodying aspects of the present invention might weigh losses due to cannibalization against increased revenue derived from the distributor when making syndication decisions.

A content provider might also want to implement sampling into the syndication decision making process. Sampling can consist of syndicating listings for a certain type of product with a certain distributor even if it is not likely to directly lead to a sale. For example, a particular distributor might be more oriented towards selling less expensive used cars, but a content provider might still want to syndicate the occasional new, luxury car listing with that distributor. A content provider might do this in order to advertise the diversity of the product line, improve reputation by showing dealing in high-end products, or for other numerous business motivations known to ordinarily skilled artisans.

The various factors can be weighted differently depending on the particular business considerations of a content provider, and each content provider can determine its own set of rules for determining the appropriate distributors. For example, a content provider that deals in highly specialized products might care more about category expertise and less about cost per listing than a content provider who deals in non-specialized products. An aspect of the present invention allows the user of the syndication system to determine which factors to include in the syndication decision making, and how to weigh each of those various factors relative to the other factors.

Referring back to FIG. 1, another aspect of the present invention calls for the distributors 140-143 to provide data back to the syndication system 120. The data can then be used by the syndication system 120 for future syndication determinations. For example, when choosing which distributors to syndicate with, the syndication system 120 may balance the estimated cost of the listing versus the estimated increase in traffic and likelihood of a sale resulting from the listing. As more listings are sent to various syndicates 140-143, data on cost, sales, traffic, etc. can be fed back to the syndication system 120 in order to improve the estimates and the decision making for future syndication decision making. Additionally, the feedback from the data from the distributors 130-132 might be routed back to the content generating systems 110-113 and then to the syndication system 120 rather than directly to the syndication system 120.

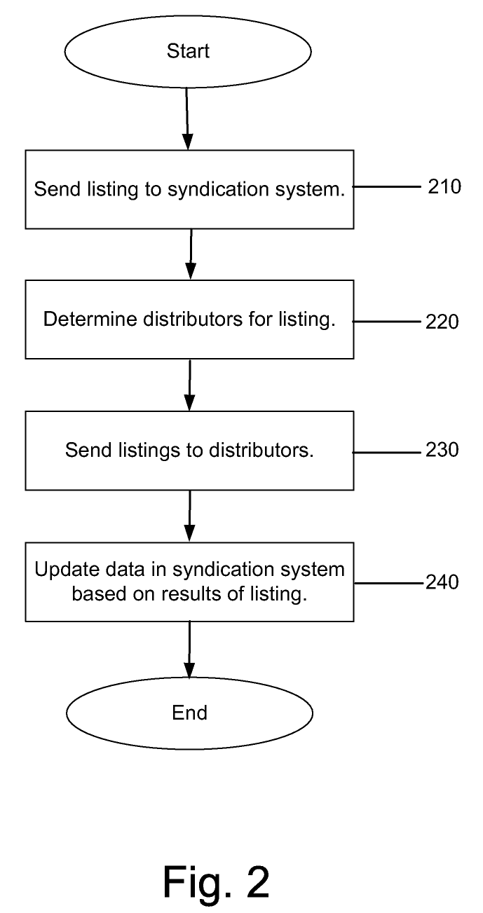

FIG. 2 provides a representation of a method embodying aspects of the present invention. A content provider prepares a listing and sends the listing to the syndication system (block 210). The syndication system determines the appropriate distributors for that particular listing based on a set of factors, and an appropriate weight for each factor, determined by the content provider (block 220). After the appropriate distributors for a particular listing are determined, the listing is sent either automatically or after the approval of a supervisor to the chosen distributors (block 230). Based on data accumulated during the course of the listing, the syndication system is updated to improve the accuracy of its future determinations (block 240).

The previous description of embodiments is provided to enable a person skilled in the art to make and use the present invention. Various modifications to these embodiments will be readily apparent to those skilled in the art, and the generic principles and specific examples defined herein may be applied to other embodiments without the use of inventive faculty. For example, some or all of the features of the different embodiments discussed above may be deleted from the embodiment. Therefore, the present invention is not intended to be limited to the embodiments described herein but is to be accorded the widest scope defined only by the claims below and equivalents thereof.

What is claimed is:

1. An automated method for syndicating web content, said method comprising:
storing data related to a plurality of content distributors in a computer readable medium;
associating a rule with a content provider, said rule based on syndicating preferences provided by said content provider; and
in response to receiving a request to syndicate a listing of web content from said content provider, executing computer code to apply said rule to said data to determine a subset of said plurality of content distributors based on said syndicating preferences of said content provider.

2. The method of claim 1, further comprising updating said data in response to a performance of said listing of web content at said subset of content distributors.

3. The method of claim 1, wherein said data comprises costs of listing for said plurality of content distributors.

4. The method of claim 1, wherein said data comprises expressions of interest of users generated by said plurality of content distributors.

5. The method of claim 1, wherein said data comprises cannibalization caused by said plurality of content distributors.

6. The method of claim 1, wherein said data comprises traffic generated by said plurality of content distributors.

7. The method of claim 1, wherein said data comprises category expertise of said plurality of content distributors.

8. The method of claim 1, wherein said data comprises sales generated by said plurality of content distributors.

9. The method of claim 1, wherein said data comprises reputations of said plurality of content distributors.

10. The method of claim 1, wherein said data is stored in a database.

11. A computer program product containing program code for performing an automated method for determining a list of content distributors, said system comprising:
storing data related to a plurality of content distributors in a computer readable medium;
associating a rule with a content provider, said rule based on syndicating preferences provided by said content provider; and
in response to receiving a request to syndicate a listing of web content from said content provider, executing computer code to apply said rule to said data to determine a subset of said plurality of content distributors based on said syndicating preferences of said content provider.

12. The computer program product of claim 11, said method further comprising updating said data in response to a performance of said listing of web content at said subset of said plurality of content distributors.

13. The computer program product of claim 11, wherein said data comprises costs of listing for said plurality of content distributors.

14. The computer program product of claim 11, wherein said data comprises expressions of interest of users generated by said plurality of content distributors.

15. The computer program product of claim 11, wherein said data comprises cannibalization caused by said plurality of content distributors.

16. The computer program product of claim 11, wherein said data comprises traffic generated by said plurality of content distributors.

17. The computer program product of claim 11, wherein said data comprises category expertise of said plurality of content distributors.

18. The computer program product of claim 11, wherein said data comprises sales generated by said plurality of content distributors.

19. The computer program product of claim 11, wherein said data comprises reputations of said plurality of content distributors.

20. The computer program product of claim 11, wherein said data is stored in a database.
